(19) United States
(12) Patent Application Publication
(10) Pub. No.: US 2008/0270347 A1
(43) Pub. Date: Oct. 30, 2008

(54) Method and apparatus for facilitating improved navigation through a list

(76) Inventors: Wei Zhou, Fremont, CA (US); Noah D. Shaffer, Pleasanton, CA (US); Surinder P. Singh, Pleasanton, CA (US)

Correspondence Address: PVF -- INTUIT, INC.;c/o PARK, VAUGHAN & FLEMING LLP, 2820 FIFTH STREET, DAVIS, CA, 95618-7759, US

(21) Appl. No.: 11/799,219

(22) Filed: Apr. 30, 2007

(51) Int. Cl. G06F 7/00

(52) U.S. Cl. 707/2; 707/E17.033

(57) ABSTRACT

One embodiment of the present invention provides a system that facilitates improved navigation through a list. During operation, the system obtains a list, wherein the list includes a set of list-entries. The system then analyzes the list to determine a set of list-properties for the list. Next, the system associates a set of identifiers with the list based on the set of list-properties. Then, the system inserts the list into a list-box. The system also inserts the set of identifiers into a scrollbar associated with the list-box, thereby enabling a user to navigate to a subset of the list by selecting an identifier which corresponds to the subset from the scrollbar.

### COLOR DRAWINGS

The patent or application file contains at least one drawing executed in color. Copies of this patent or patent application publication with color drawing(s) will be provided by the Office upon request and payment of the necessary fee.

### BACKGROUND

### RELATED ART

Many computer applications are designed to help users organize and access large quantities of data. These computer applications often include list-boxes, which present a user with a list of entries or items that the user can browse or select. Currently, if the user desires to select an entry from the list that is not in view, the user must scroll through the list to locate the desired list-entry. For a list that is very large, or for an application that cannot dedicate a large amount of screen-space to the list, scrolling through the list to find the desired list-entry can be both time-consuming and inconvenient for the user. Furthermore, for a very large list, operating the scrollbar during navigation through the list can be difficult because each tiny movement of the scrollbar may correspond to a shift of many list-entries in the list-box.

### SUMMARY

One embodiment of the present invention provides a system that facilitates improved navigation through a list. During operation, the system obtains a list, wherein the list includes a set of list-entries. The system then analyzes the list to determine a set of list-properties for the list. Next, the system associates a set of identifiers with the list based on the set of list-properties. Then, the system inserts the list into a list-box. The system also inserts the set of identifiers into a scrollbar associated with the list-box, thereby enabling a user to navigate to a subset of the list by selecting an identifier which corresponds to the subset from the scrollbar.

In a variation on this embodiment, the system receives a configuration file from the user. The system then selects the set of identifiers based on the configuration file and the set of list-properties.

In a variation on this embodiment, the set of identifiers can include: letters, numbers, colors, time-stamps, symbols, shapes, and icons.

In a variation on this embodiment, when the user selects an identifier, the system presents a corresponding subset of the list to the user, wherein at least one list-entry in the subset is associated with the identifier.

In a further variation, when the user selects the identifier from the set of identifiers, the system replaces the list with the corresponding subset of the list in the list-box.

In a variation on this embodiment, when the user points to a potential identifier which the user can potentially select, the system emphasizes the potential identifier.

In a further variation, emphasizing the potential identifier can involve: highlighting the potential identifier; enlarging the potential identifier; shrinking the other identifiers in the set of identifiers without shrinking the potential identifier; and presenting a tool-tip to the user, wherein the tool-tip specifies the subset of the list associated with the potential identifier.

In a variation on this embodiment, inserting the set of identifiers into the scrollbar can involve inserting a given identifier multiple times, wherein each instance of the given identifier is associated with a different portion of a corresponding subset of the list.

In a variation on this embodiment, associating the set of identifiers with the list involves associating each identifier with a subset of the list.

In a variation on this embodiment, associating the set of identifiers with the list involves associating multiple identifiers with a given subset of the list.

### BRIEF DESCRIPTION OF THE FIGURES

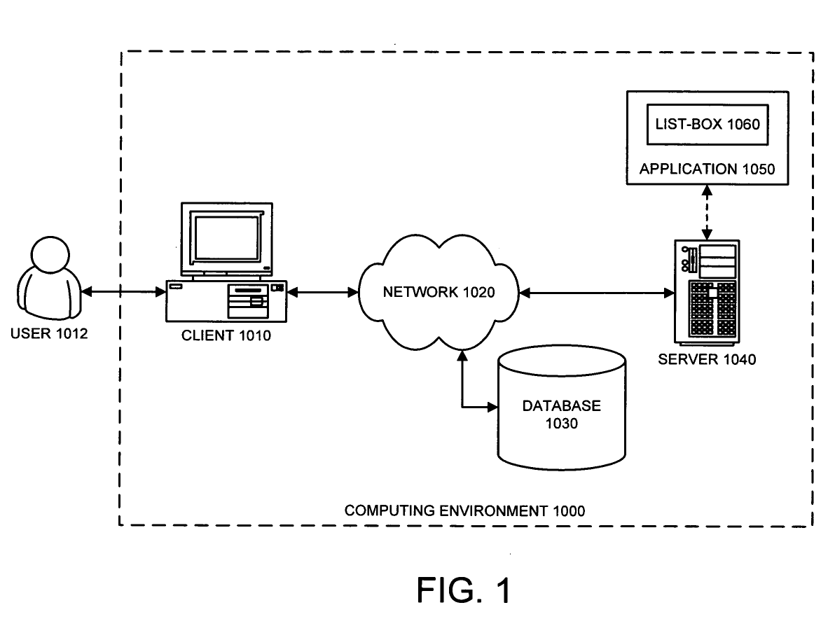

FIG. 1 illustrates a computing environment in accordance with an embodiment of the present invention.

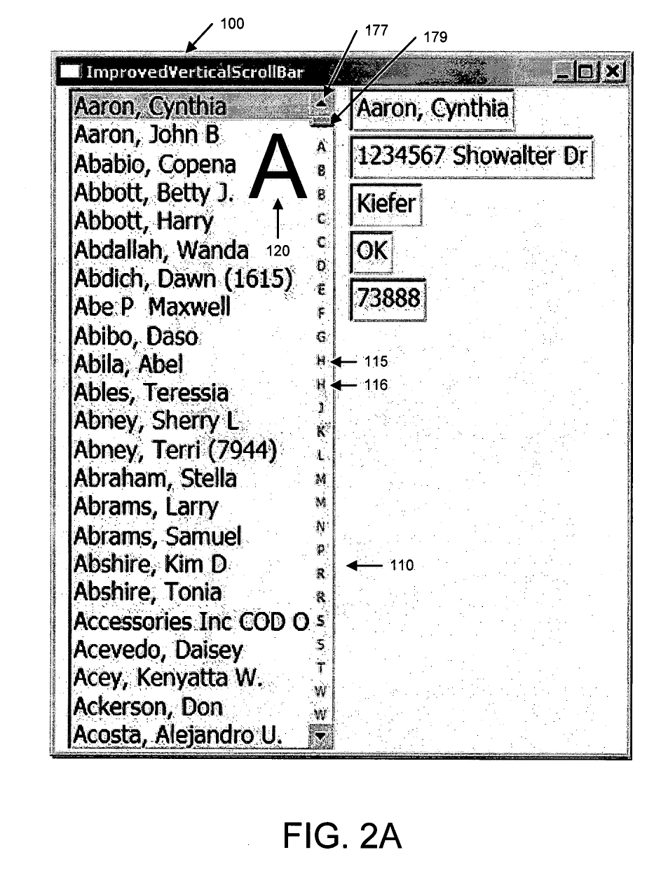

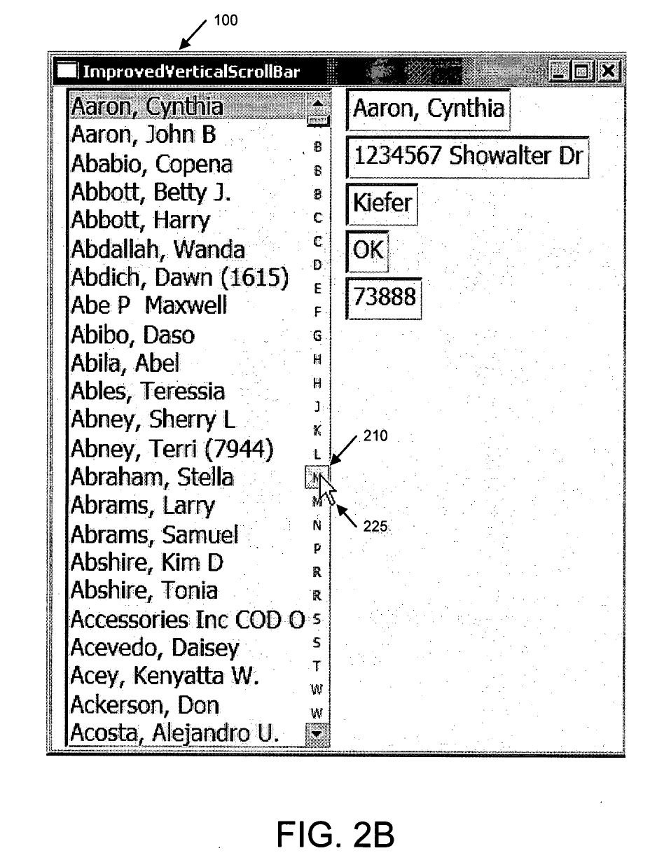

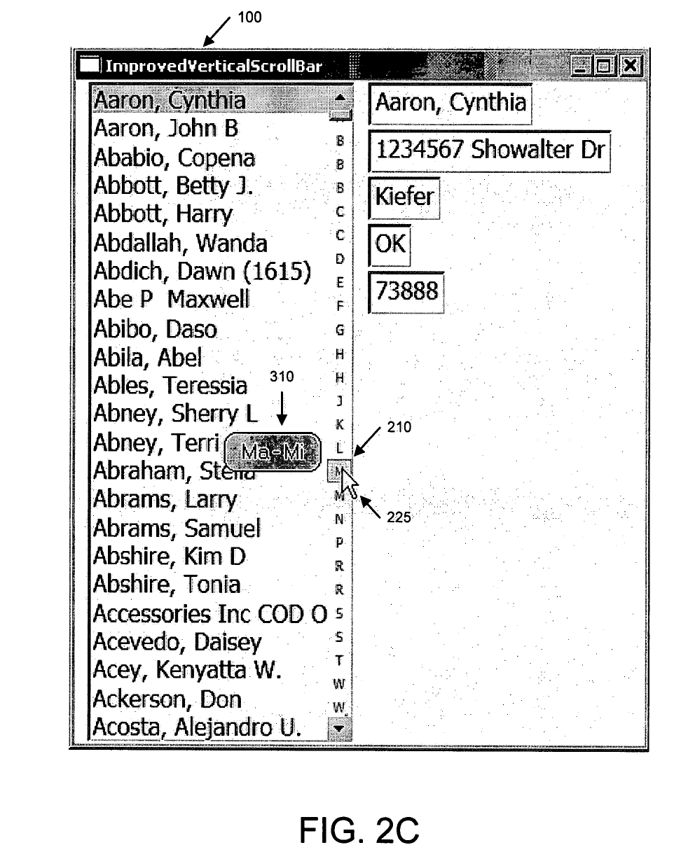

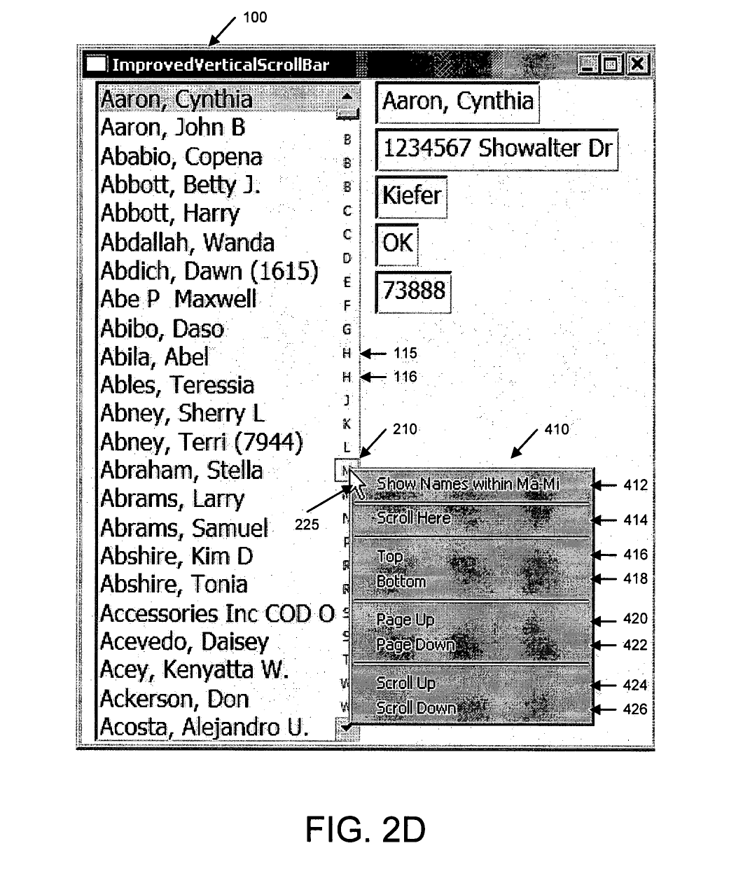

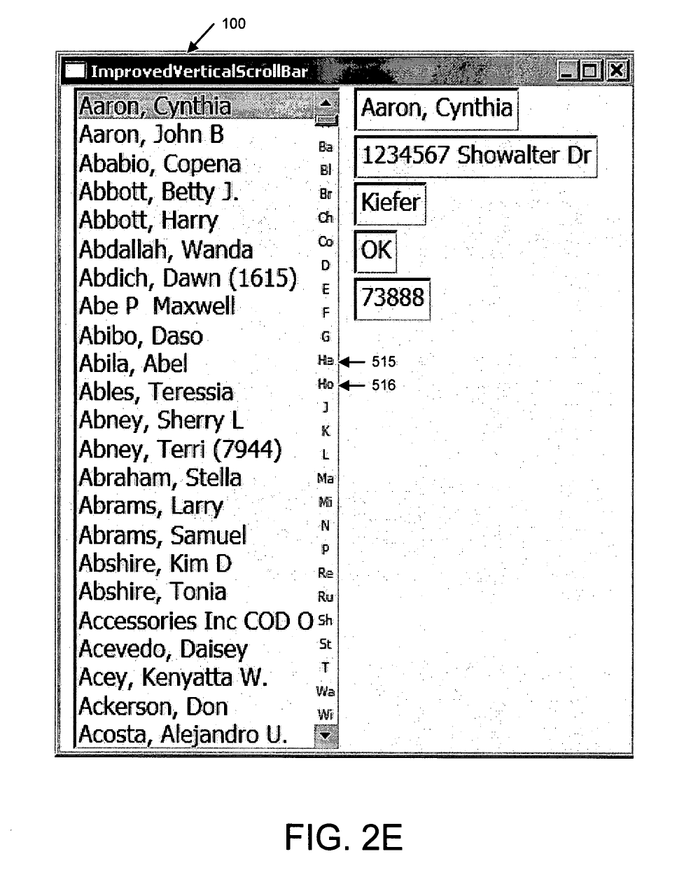

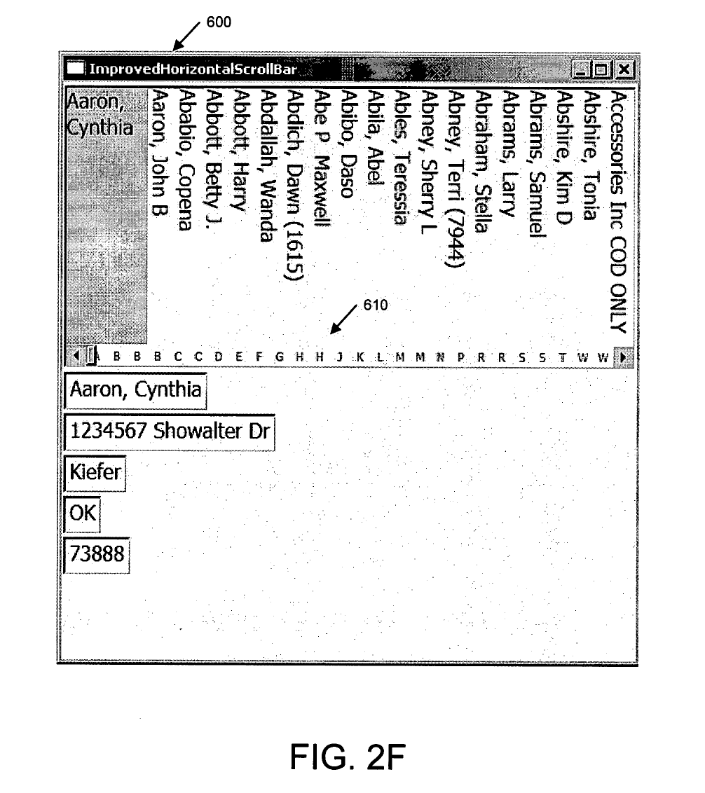

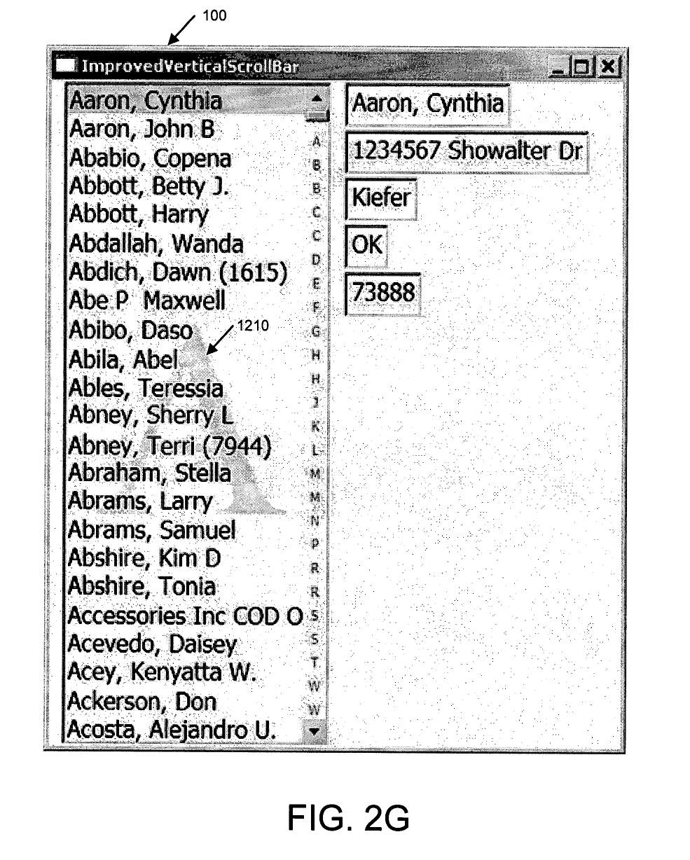

FIG. 2A illustrates an example of a list-box in accordance with an embodiment of the present invention.

FIG. 2B illustrates a second example of a list-box in accordance with an embodiment of the present invention.

FIG. 2C illustrates a third example of a list-box in accordance with an embodiment of the present invention.

FIG. 2D illustrates a fourth example of a list-box in accordance with an embodiment of the present invention.

FIG. 2E illustrates a fifth example of a list-box in accordance with an embodiment of the present invention.

FIG. 2F illustrates a sixth example of a list-box in accordance with an embodiment of the present invention.

FIG. 2G illustrates a seventh example of a list-box in accordance with an embodiment of the present invention.

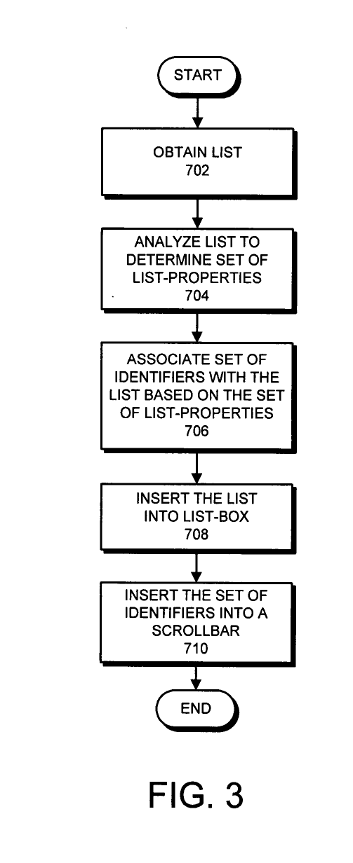

FIG. 3 presents a flowchart illustrating a process for facilitating improved navigation through a list in accordance with an embodiment of the present invention.

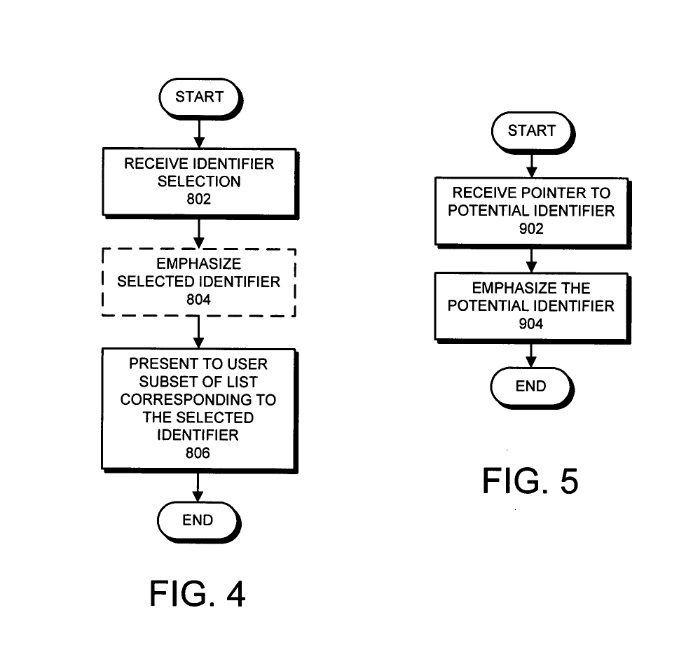

FIG. 4 presents a flowchart illustrating a process for navigating a list in accordance with an embodiment of the present invention.

FIG. 5 presents a flowchart illustrating a process for emphasizing a potential identifier in accordance with an embodiment of the present invention.

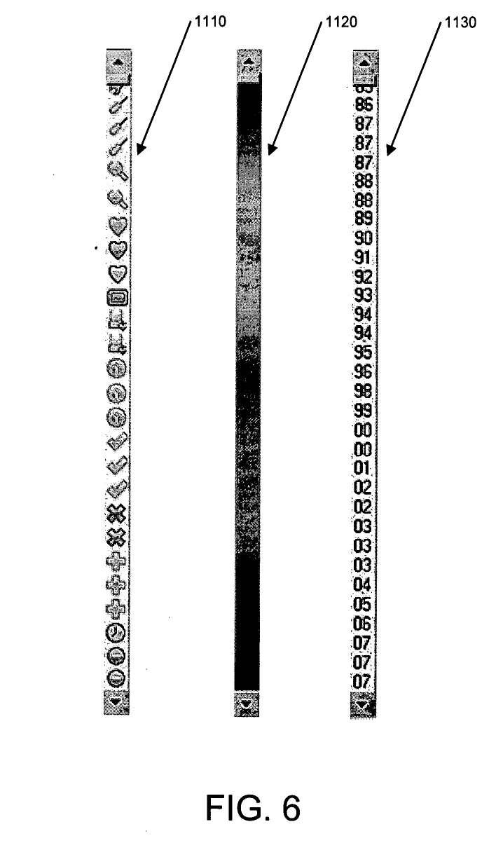

FIG. 6 illustrates several examples of scrollbars in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

One embodiment of the present invention provides a system which implements a list-box which includes an improved scrollbar. This system can analyze a list received from a user to determine a set of identifiers associated with the list. Then, the list-box can insert the identifiers into the improved scrollbar.

In one embodiment of the present invention, upon a user selecting an identifier from the improved scrollbar, the system can scroll or jump directly to the subset of the list corresponding to the identifier.

In one embodiment of the present invention, the user can select the identifier from the scrollbar by: placing a cursor over the identifier and double clicking a mouse button; pressing a hotkey or a combination of hotkeys from a keyboard; selecting an option from a menu, which can be part of a menu bar or can be accessed by clicking a mouse button; or any other method for selecting an identifier from a scrollbar.

In one embodiment of the present invention, the list can be a sorted list. Note that the list can be sorted based on any attribute that can be sorted, such as: character strings, numbers, insertion time-stamps, colors, etc.

### Computing Environment

FIG. 1 illustrates a computing environment 1000 in accordance with an embodiment of the present invention. Computing environment 1000 includes a number of computer systems, which can generally include any type of computer system based on: a microprocessor, a mainframe computer, a digital signal processor, a portable computing device, a personal organizer, a device controller, or a computational engine within an appliance. More specifically, computing environment 1000 includes client 1010, network 1020, database 1030, server 1040, application 1050, and list-box 1060.

Client 1010 can generally include any node on a network including computational capability and including a mechanism for communicating across the network.

Network 1020 can generally include any type of wired or wireless communication channel capable of coupling together computing nodes. This includes, but is not limited to, a local area network, a wide area network, or a combination of networks. In one embodiment of the present invention, network 1020 comprises the Internet.

Database 1030 can generally include any type of system for storing data in non-volatile storage. This includes, but is not limited to, systems based upon: magnetic, optical, and magneto-optical storage devices, as well as storage devices based on flash memory and/or battery-backed up memory. In one embodiment of the present invention, database 1030 can store lists.

Server 1040 can generally include any computational node including a mechanism for servicing requests from a client for computational and/or data storage resources. Furthermore, server 1040 can generally include any system that can host application 1050.

In one embodiment of the present invention, client 1010 hosts application 1050.

Application 1050 can generally include any application that includes a list-box, such as list-box 1060.

In one embodiment of the present invention, a third-party application can include and/or use application 1050.

In one embodiment of the present invention, application 1050 can be a stand-alone system.

List-box 1060 can generally include any widget that can display a list. Furthermore, list-box 1060 can be associated with any navigation-widget, such as a scrollbar, for facilitating navigation through the list.

In one embodiment of the present invention, the navigation-widget can include: a scrollbar, a slider, navigation-arrows, and any other widget for navigating a list.

User 1012 can generally include: an individual; a group of individuals; an organization; a group of organizations; a computing system; a group of computing systems; or any other entity that can interact with computing environment 1000.

In one embodiment of the present invention, user 1012 can be a client.

### List-Box Examples

FIG. 2A illustrates an example of a list-box 100 in accordance with an embodiment of the present invention. List-box 100 includes a list of items or list-entries. However, as a result of the number of list-entries in a list and the size of the screen-space available to list-box 100, list-box 100 can usually only present a subset of the list to user 1012 at any given time. For example, although list-box 100 includes list-entries associated with several identifiers, list-box 100 currently only displays list-entries associated with the “A” identifier. List-box 100 includes scrollbar 110, which can include a set of identifiers associated with subsets of the list. Each identifier can be associated with a given subset of the list. Furthermore, if the size of the given subset exceeds a threshold, list-box 100 can duplicate a given identifier, such as identifier 115. In this case, list-box 100 can associate each copy of the given identifier with a different portion of the given subset. Thus, list-box 100 can associate the first half of the list-entries starting with “H” with identifier 115 and the second half of the list-entries starting with “H” with identifier 116.

In one embodiment of the present invention, one of the identifiers in list-box 100 can include a selected-identifier 120, which user 1012 selected from scrollbar 110.

In one embodiment of the present invention, selected-identifier 120 can be indicated by a visible watermark located behind the list. Note that the visible watermark is translucent enough to not obscure the list.

In one embodiment of the present invention, scrollbar 110 includes all possible identifiers from a set of identifiers. In this embodiment, scrollbar 110 may include identifiers which are not associated with any list-entries.

In one embodiment of the present invention, scrollbar 110 only includes identifiers associated with existing list-entries. For example, if the list in list-box 100 does not include any list-entries beginning with the letter “O,” then scrollbar 110 does not include an “0” identifier.

FIG. 2B illustrates a second example of a list-box 100 in accordance with an embodiment of the present invention. In this example, list-box 100 emphasizes identifier 210 by placing a shaded box around identifier 210. This emphasis can occur in response to a user 1012 request, for example, by pointing to identifier 210 via cursor 225.

FIG. 2C illustrates a third example of a list-box 100 in accordance with an embodiment of the present invention. In this example, list-box 100 presents tool-tip 310 to user 1012 in response to a request by user 1012 for a tool-tip 310, for example, by pointing cursor 225 at identifier 210. Tool-tip 310 specifies the range of list-entries associated with identifier 210 by displaying information associated with the subset of the list associated with identifier 210.

In one embodiment of the present invention, tool-tip 310 can display any information that can assist user 1012 with making a decision about which identifier to select.

FIG. 2D illustrates a fourth example of a list-box 100 in accordance with an embodiment of the present invention. In this example, list-box 100 presents option-menu 410 to user 1012 when user 1012 requests access to option-menu 410, such as by right-clicking on identifier 210. Option-menu 410 can include: filter-option 412; scroll-here option 414; top-option 416; bottom-option 418; page-up option 420; page-down option 422; scroll-up option 424; and scroll-down option 426. Furthermore, option-menu 410 can include any other option that facilitates accessing and navigating through a list.

Filter-option 412 enables user 1012 to replace the list in list-box 100 with a subset of the list associated with a specific instance of an identifier, such as identifier 210, that user 1012 selects or points to.

In one embodiment of the present invention, option-menu 410 includes an option to replace the list in list-box 100 with a subset of the list associated with all instances of an identifier. For example, if user 1012 selects identifier 115, application 1050 can replace the list with a combination of the subset of the list associated with identifier 115 and the subset of the list associated with identifier 116.

In one embodiment of the present invention, option-menu 410 includes an option to replace the subset of the list with the complete list.

In one embodiment of the present invention, option-menu 410 includes an option to replace the subset of the list with a previously displayed subset of the list. This enables user 1012 to reverse or undo previous filtering operations.

Scroll-here option 414 enables user 1012 to scroll to the subset of the list associated with identifier 210. Note that the remaining portion of the list is still included in list-box 100, but due to the limited screen-space available to list-box 100, the remaining portion of the list may not be visible.

Top-option 416 enables user 1012 to scroll to the top of the list, which involves displaying the beginning of the list.

Bottom-option 418 enables user 1012 to scroll to the bottom of the list, which involves displaying the end of the list.

Page-up option 420 enables user 1012 to replace the subset of the list that list-box 100 is currently displaying with a preceding subset of the list.

Page-down option 422 enables user 1012 to replace the subset of the list that list-box 100 is currently displaying with a following subset of the list.

Scroll-up option 424 enables user 1012 to shift up the subset of the list that list-box 100 is currently displaying by one list-entry.

Scroll-down option 426 enables user 1012 to shift down the subset of the list that list-box 100 is currently displaying by one list-entry.

FIG. 2E illustrates a fifth example of a list-box 100 in accordance with an embodiment of the present invention. In this example, list-box 100 replaces duplicate single-letter identifiers, such as identifiers 115 and 116, with multi-letter identifiers, such as identifiers 515 and 516. This enables user 1012 to determine which copy of an identifier is associated with a subset of the list without pointing to or selecting the identifier.

FIG. 2F illustrates a sixth example of a list-box 600 in accordance with an embodiment of the present invention. In this example, list-box 600 is a horizontal version of list-box 100. List-box 600 similarly includes scroll-bar 610, which is a horizontal version of scroll-bar 110. Note that list-box 600 and scroll-bar 610 can generally have any shape or orientation. For example, list-box 600 and scroll-bar 610 can have a diagonal orientation, or a step shape.

In one embodiment of the present invention, scroll-bar 610 can be a slider, or any other widget that facilitates navigating or traversing a list.

In one embodiment of the present invention, list-box 600 can be a drop-down box, or any other widget that facilitates displaying a list to user 1012.

FIG. 2G illustrates a seventh example of a list-box in accordance with an embodiment of the present invention. In this example, list-box 100 includes selected-identifier 1210, which specifies the selected identifier and is an example of a visible watermark. Note that selected-identifier 1210 can be any color.

### Facilitating Improved Navigation Through a List

FIG. 3 presents a flowchart illustrating a process for facilitating improved navigation through a list in accordance with an embodiment of the present invention. The process begins when application 1050 obtains a list (operation 702). Note that the list can include any number of list-entries and the list-entries can include any type of data.

In one embodiment of the present invention, application 1050 can obtain the list: from an application that is part of application 1050 (i.e., a subset of application 1050); from user 1012; from database 1020; from client 1010; by generating the list; or from any other system or application that can provide a list to application 1050.

Application 1050 then analyzes the list to determine a set of list-properties for the list (operation 704). These list properties can include: letters associated with the list-entries; time-stamps associated with the list-entries; numerical attributes associated with the list-entries, such as the number of times a user selected a list-entry; and any other information that can facilitate sorting the list-entries and identifying a specific list-entry. Next, application 1050 associates a set of identifiers with the list based on the set of list-properties (operation 706).

In one embodiment of the present invention, application 1050 receives a configuration file from user 1012 via client 1010. This configuration file can include: list-properties; a specification of identifiers to associate with the list; a specification of identifier-types to associate with the list; and any other information that can facilitate associating the set of identifiers with the list. Application 1050 then selects the set of identifiers to associate with the list based on the configuration file and the set of list-properties.

In one embodiment of the present invention, application 1050 can obtain the configuration file: from user 1012; from client 1010; from database 1020; from an application that is part of application 1050 (i.e., a subset of application 1050); or from any other system or application that can provide the configuration file to application 1050.

In one embodiment of the present invention, the set of identifiers can include: letters, numbers, colors, time-stamps, symbols, shapes, icons, and any other type of identifier that application 1050 can associate with list-entries. For example, the identifiers can correspond to the first letter (or first subset of letters) from a set of list-entries. In another example, the identifiers can correspond to the time (truncated to the hour) that list-entries were added to the list.

FIG. 6 illustrates several examples of scrollbars in accordance with an embodiment of the present invention. Scrollbar 1110 illustrates an example of a scrollbar that includes icons as identifiers. Scrollbar 1120 illustrates an example of a scrollbar that includes colors as identifiers. Scrollbar 1130 illustrates an example of a scrollbar that includes numbers as identifiers. Note that scrollbar 110 can include any type of identifier.

In one embodiment of the present invention, an identifier can be a combination of identifiers. For example, application 1050 can associate a combination of a letter and a color with a list-entry or set of list-entries.

In one embodiment of the present invention, associating the set of identifiers with the list involves associating each identifier with a subset of the list.

In one embodiment of the present invention, associating the set of identifiers with the list involves associating multiple identifiers with a given subset of the list.

Application 1050 then inserts the list into list-box 100 (operation 708).

In one embodiment of the present invention, inserting the list into list-box 100 can involve inserting a given identifier multiple times, wherein application 1050 can associate each instance of the given identifier with a different portion of a subset of the list which is associated with the given identifier.

Next, application 1050 inserts the set of identifiers into scrollbar 110 (operation 710). This enables user 1012 to navigate to a subset of the list by selecting from scrollbar 1012 an identifier corresponding to the subset of the list.

In one embodiment of the present invention, selecting an identifier can involve: single-clicking a button on a pointing device, such as a mouse; double-clicking a button on the pointing device; right clicking a mouse button; pressing a button on an input device, such as a key on a keyboard; holding down the key on the input device; selecting scroll-here option 414 from option-menu 410; moving a cursor over the identifier; and any other method for selecting an identifier from scrollbar 110.

### Navigating a List

FIG. 4 presents a flowchart illustrating a process for navigating through a list in accordance with an embodiment of the present invention. The process begins when application 1050 receives an identifier selection from user 1012 (operation 802).

In one embodiment of the present invention, application 1050 can receive the identifier selection from client 1010.

Next, application 1050 emphasizes the selected identifier (operation 804). Note that emphasizing the selected identifier can involve: highlighting the selected identifier; enlarging the selected identifier; shrinking the other identifiers in a set of identifiers without shrinking the selected identifier; inserting a watermark or identifier-tag, such as selected-identifier 120, into list-box 100; inserting a copy of the selected identifier into scroll-bar arrow 177; replacing scroll-bar thumb 179 with a copy of the selected identifier; and any other method for emphasizing the selected identifier. Furthermore, note that operation 804 is optional as is illustrated by the dashed lines surrounding operation 804.

Application 1050 then presents to user 1012 a subset of the list corresponding to the selected identifier (operation 806). Note that the corresponding subset includes at least one list-entry that is associated with the selected identifier.

In one embodiment of the present invention, presenting the subset of the list involves scrolling or jumping to the corresponding subset of the list. In this embodiment, application 1050 changes the visible portion of the list without removing list-entries from list-box 100.

In one embodiment of the present invention, presenting the subset of the list involves replacing the list with the corresponding subset of the list.

In one embodiment of the present invention, the corresponding subset of the list may be larger than the number of list-entries user 1012 can view at any given moment in time. In this embodiment, application 1050 presents the beginning portion of the corresponding subset of the list to user 1012.

In one embodiment of the present invention, application 1050 can emphasize the subset of the list corresponding to the selected identifier. For example, if the selected identifier is the color blue, application 1050 can highlight in blue the corresponding subset of the list.

### Emphasizing a Potential Identifier

FIG. 5 presents a flowchart illustrating a process for emphasizing a potential identifier in accordance with an embodiment of the present invention. Note that a potential identifier is an identifier that user 1012 has indicated that user 1012 may select, but has not yet selected; for example, an identifier that user 1012 places or moves cursor 225 over. The process begins when application 1050 receives a pointer to a potential identifier (operation 902). Application 1050 subsequently emphasizes the potential identifier (operation 904). Note that emphasizing the potential identifier can involve: highlighting the potential identifier; enlarging the potential identifier; shrinking the other identifiers in a set of identifiers without shrinking the potential identifier; hiding the other identifiers in the set of identifiers without hiding the potential identifier; presenting tool-tip 310 to user 1012, wherein tool-tip 310 specifies the subset of the list associated with the potential identifier; and any other method for emphasizing the potential identifier.

In one embodiment of the present invention, highlighting the potential identifier can involve: altering the color of the potential identifier; encircling the potential identifier in a colored polygon; and any other method for highlighting a potential identifier.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for facilitating improved navigation through a list, the method comprising:
obtaining a list, wherein the list includes a set of list-entries;
analyzing the list to determine a set of list-properties for the list;
associating a set of identifiers with the list based on the set of list-properties;
inserting the list into a list-box; and
inserting the set of identifiers into a scrollbar associated with the list-box, thereby enabling a user to navigate to a subset of the list by selecting an identifier which corresponds to the subset from the scrollbar.

2. The method of claim 1, further comprising:
receiving a configuration file from the user; and
selecting the set of identifiers based on the configuration file and the set of list-properties.

3. The method of claim 1, wherein the set of identifiers can include:
letters;
numbers;
colors;
time-stamps;
symbols;
shapes; and
icons.

4. The method of claim 1, wherein when the user selects an identifier, the method further comprises presenting a corresponding subset of the list to the user, wherein at least one list-entry in the subset is associated with the identifier.

5. The method of claim 4, wherein when the user selects the identifier from the set of identifiers, the method further comprises replacing the list with the corresponding subset of the list in the list-box.

6. The method of claim 1, wherein when the user points to a potential identifier which the user can potentially select, the method further comprises emphasizing the potential identifier.

7. The method of claim 6, wherein emphasizing the potential identifier can involve:
highlighting the potential identifier;
enlarging the potential identifier;
shrinking the other identifiers in the set of identifiers without shrinking the potential identifier; and
presenting a tool-tip to the user, wherein the tool-tip specifies the subset of the list associated with the potential identifier.

8. The method of claim 1, wherein inserting the set of identifiers into the scrollbar can involve inserting a given identifier multiple times, wherein each instance of the given identifier is associated with a different portion of a corresponding subset of the list.

9. The method of claim 1, wherein associating the set of identifiers with the list involves associating each identifier with a subset of the list.

10. The method of claim 1, wherein associating the set of identifiers with the list involves associating multiple identifiers with a given subset of the list.

11. A computer-readable storage medium storing instructions that when executed by a computer cause the computer to perform a method for facilitating improved navigation through a list, the method comprising:
obtaining a list, wherein the list includes a set of list-entries;
analyzing the list to determine a set of list-properties for the list;
associating a set of identifiers with the list based on the set of list-properties;
inserting the list into a list-box; and
inserting the set of identifiers into a scrollbar associated with the list-box, thereby enabling a user to navigate to a subset of the list by selecting an identifier which corresponds to the subset from the scrollbar.

12. The computer-readable storage medium of claim 11, the method further comprising:
receiving a configuration file from the user; and
selecting the set of identifiers based on the configuration file and the set of list-properties.

13. The computer-readable storage medium of claim 11, wherein the set of identifiers can include:
letters;
numbers;
colors;
time-stamps;
symbols;
shapes; and
icons.

14. The computer-readable storage medium of claim 11, wherein when the user selects an identifier, the method further comprises presenting a corresponding subset of the list to the user, wherein at least one list-entry in the subset is associated with the identifier.

15. The computer-readable storage medium of claim 14, wherein when the user selects the identifier from the set of identifiers, the method further comprises replacing the list with the corresponding subset of the list in the list-box.

16. The computer-readable storage medium of claim 11, wherein when the user points to a potential identifier which the user can potentially select, the method further comprises emphasizing the potential identifier.

17. The computer-readable storage medium of claim 16, wherein emphasizing the potential identifier can involve:
highlighting the potential identifier;
enlarging the potential identifier;
shrinking the other identifiers in the set of identifiers without shrinking the potential identifier; and
presenting a tool-tip to the user, wherein the tool-tip specifies the subset of the list associated with the potential identifier.

18. The computer-readable storage medium of claim 11, wherein inserting the set of identifiers into the scrollbar can involve inserting a given identifier multiple times, wherein each instance of the given identifier is associated with a different portion of a corresponding subset of the list.

19. The computer-readable storage medium of claim 11, wherein associating the set of identifiers with the list involves associating each identifier with a subset of the list.

20. The computer-readable storage medium of claim 11, wherein associating the set of identifiers with the list involves associating multiple identifiers with a given subset of the list.

21. An apparatus that facilitates improved navigation through a list, comprising:
an obtaining mechanism configured to obtain a list, wherein the list includes a set of list-entries;
an analysis mechanism configured to analyze the list to determine a set of list-properties for the list;
an association mechanism configured to associate a set of identifiers with the list based on the set of list-properties;
an insertion mechanism configured to insert the list into a list-box; and
wherein the insertion mechanism is further configured to insert the set of identifiers into a scrollbar associated with the list-box, thereby enabling a user to navigate to a subset of the list by selecting an identifier which corresponds to the subset from the scrollbar.

22. The apparatus of claim 21, wherein the receiving mechanism is further configured to receive a configuration file from the user, and
wherein the apparatus further comprises a selection mechanism configured to select the set of identifiers based on the configuration file and the set of list-properties.

23. The apparatus of claim 21, further comprising a presentation mechanism configured to present a subset of the list to the user when the user selects a corresponding identifier, wherein at least one list-entry in the subset is associated with the identifier.

24. The apparatus of claim 23, further comprising a replacement mechanism configured to replace the list with the subset of the list in the list-box upon the user selecting the corresponding identifier from the set of identifiers.

25. The apparatus of claim 21, further comprising an emphasizing mechanism configured to emphasize a potential identifier upon the user pointing to the potential identifier which the user can potentially select.

26. The apparatus of claim 25, wherein the emphasizing mechanism can further comprise:
a highlighting mechanism configured to highlight the potential identifier;
an enlarging mechanism configured to enlarge the potential identifier;
a shrinking mechanism configured to shrink the other identifiers in the set of identifiers without shrinking the potential identifier; and
a presentation mechanism configured to present a tool-tip to the user, wherein the tool-tip specifies the subset of the list associated with the potential identifier.

27. The apparatus of claim 21, wherein the insertion mechanism is further configured to insert the set of identifiers into the scrollbar by inserting a given identifier multiple times, wherein each instance of the given identifier can be associated with a different portion of a corresponding subset of the list.

28. The apparatus of claim 21, wherein the association mechanism is further configured to associate each identifier with a subset of the list.

29. The apparatus of claim 21, wherein the association mechanism is further configured to associate multiple identifiers with a given subset of the list.
